(19) United States
(12) Patent Application Publication
(10) Pub. No.: US 2024/0050956 A1
(43) Pub. Date: Feb. 15, 2024

(54) GLASS CYLINDER WITH SPECIAL GRADUATIONS FOR REMAINING VOLUME FOR THE PREPARATION OF CAPSULES IN CAPSULES

(71) Applicant: SM Empreedimentos Farmacêuticos Ltda., São Paulo/SP (BR)

(72) Inventor: Anderson de Oliveira Ferreira, Juiz de Fora/MG (BR)

(73) Assignee: SM Empreedimentos Farmacêuticos Ltda., São Paulo/SP (BR)

(21) Appl. No.: 18/233,082

(22) Filed: Aug. 11, 2023

(30) Foreign Application Priority Data
Aug. 12, 2022 (BR) 202022016094-0

(51) Int. Cl. B01L 3/00

(52) U.S. Cl. CPC B01L 3/569

(57) ABSTRACT

The present application refers to a test-tube-type glass cylinder, with special and differentiated graduations, destined to fill the remaining volume in the compounding preparation of capsules of different sizes “combined”, where there is a capsule inside another capsule. The model allows the filling of the external capsule in combination with several sizes of internal capsules, allows the combination of different dosages of the same drug with different release times and solid mixtures with different particle sizes, as well as the combination of different drugs, with precision, quickly, practically and without the use of calculations.

### CROSS-REFERENCE TO RELATED APPLICATION

This application claims benefit of Brazilian patent application Serial No. 202022016094-0 filed Aug. 12, 2022, the disclosure of which is hereby incorporated by reference in its entirety.

### FIELD OF APPLICATION

The present application refers to a test-tube-type glass cylinder, with special and differentiated graduations, destined to fill the remaining volume in the compounding preparation of capsules of different sizes “combined”, where there is a capsule inside another capsule.

### BACKGROUND

Document BR112013001476 proposes an apparatus and process for the production of soft gelatin capsules (softgel) incorporating therein other solid dosage forms selected from the group consisting of pellets, smaller capsules, smaller tablets, solid sustained release dosage forms, immediate release solid dosage forms, sustained release solid dosage forms, and zero order release solid dosage forms, said apparatus comprising: (a) two dispensing boxes; (b) two casting drums; (c) a pair of rotating dies having means for suction; (d) a liquid filling system; (e) a wedge for heating gelatin ribbons and feeding said filling; and (f) two lateral dispensing devices, said lateral dispensing devices including hoppers containing said solid dosage forms, channel guides for transporting said solid dosage forms and a gripper for dispensing said dosage form solid in the pocket of soft gelatin formed on the rotating dies. This device is ideal for industrial use, but impracticable for compounding use, with several components, more energy expenditure. Different from the cylinder with special graduation for remaining volume, intended herein, that is easy to use, manual, ideal for compounding scale and individualization of capsules.

Document BR112020000384 provides a capsule with a dual dosage form, methods for the production thereof and systems for manufacturing the same, which can provide dual release of the two dosages. The capsule with a dual dosage form has a first capsule member containing a first fill material and a second capsule member containing a second fill material. A band couples the first capsule member to the second capsule member and forms a third chamber defined by an interior surface of the band and each lid of the capsule members. An opening allows fluid to enter the third chamber, causing the band to at least partially dissolve so that the caps of the capsule members are exposed. Capsule member caps can dissolve at the same or different rates to control the release time of the first and second fill materials and therefore an active ingredient included in the fill material. Here, too, it bears no resemblance to the cylinder with special graduation for remaining volume.

Document BR122020023630, divided from document BR112013001476, refers to a specific part of the matter disclosed in the “parent” application. It claims a process for making a soft gelatin capsule having another capsule incorporated therein, comprising: (a) feeding sheets of film between a first die roll and a second die roll wherein each die roll has capsule pockets in a plurality of rows and said capsule pockets have at least one hole for applying suction; (b) applying suction while said film is placed in the capsule pockets; (c) feeding through guide channels through a lateral dispensing device having a hopper and gripper to grab pre-formed smaller capsules onto the film sheets overlying the die rolls at positions that have the capsule pockets; (d) filling said capsule pockets also through a wedge segment with a liquid medical formulation; and (e) cutting the foil sheets around the capsule pockets to form said soft gel capsules with capsules in combination with a suitable liquid pharmaceutical blend. Also claimed are soft gelatin capsules incorporated in an external soft gelatin capsule, tablets incorporated in an external softgel capsule, microgranules incorporated in an external soft gelatin capsule and any combination of soft gelatin capsules, tablets and/or incorporated microgranules in an external soft gelatin capsule. The divided application also claims a soft gelatin capsule having incorporated therein another solid dosage form selected from the group consisting of: (a) one capsule that contains an omega oil and wherein the other solid dosage form is a capsule with a statin; (b) one capsule that contains a non-steroidal anti-inflammatory and wherein the other solid dosage form contains an antihistamine; and (c) one capsule that contains an omega oil and wherein the other solid dosage form contains a salicylate. Here, as in document BR112013001476, there is no focus on the glass cylinder with special graduation for filling the remaining volume of said capsules in combination

As can be seen, all these models are nothing like the intended device for capsule-to-capsule manipulation.

Document BR2020200140324, which belongs to the applicant for this patent application, provides a glass cylinder (test tube type) with special and differentiated graduations for use in the compounding preparation of hard capsules. The technical solution adopted by the present application allows an appropriate choice of the size of the capsule to be used, as well as the exact definition of the amount of excipient necessary for the complete volumetric filling, with total precision and in a practical and fast way. The device determines the real apparent volume of the formulation (mixture in powder form) that is being manipulated/compounded, allowing the complete filling of the same and avoiding weight variation between the multiple units of capsules manipulated. This device allows the filling of the internal capsule.

### SUMMARY

The device according to the present application provides a glass cylinder with special markings for filling the remaining volume, the space between the internal capsule and the external capsule (FIG. 4), according to the size of each capsule.

One way to calculate the remaining volume is using the table described by HAUSS in 2007, Table 1.

TABLE 1
Capacities (approximate remaining volume) of the inner and outer capsule
combination for preparing DUO capsules.

| | Size of the internal capsule | | | | | | |
|---|---|---|---|---|---|---|---|
| | #000 | #00 | #0 | #1 | #two | #3 | #4 |
| Capsule capacity (mL) | 1.36 | 0.95 | 0.67 | 0.48 | 0.37 | 0.27 | 0.20 |
| Internal capsule capacity | N/A | N/A | 0.67/ | N/U | N/U | N/U | N/U |
| (mL)/#000 of external | | | 0.546 | | | | |
| Capacity of the internal capsule | N/A | N/A | N/A | 0.435/ | 0.325/ | 0.250/ | 0.190/ |
| (mL)/# 00 of the external one | | | | 0.235 | 0.375 | 0.510 | 0.585 |
| Capacity of the internal capsule | | N/A | N/A | N/A | 0.325/ | 0.250/ | 0.190/ |
| (mL)/# 0 of the external one | | | | | 0.140 | 0.255 | 0.355 |
| Capacity of the inner capsule | | N/A | N/A | N/A | N/A | 0.250/ | 0.190/ |
| (mL)/# 1 of the outer one | | | | | | 0.110 | 0.222 |
| Capacity of the internal capsule | | N/A | N/A | N/A | N/A | N/A | 0.190/ |
| (mL)/# 2 of the external one | | | | | | | 0.076 |

# = capsule size.
N/A = combination not applicable
N/U = not used

As an example, one may consider the preparation of 30 DUO capsules, where the outer capsule is size 00 and the inner capsule 3. What would be the total volume of powder (IFA+excipient) needed to fill the remaining volume of the outer capsule?
VT=Number of capsules to be prepared×VR_{capsules·external} (See table 1)
Where:
VT=volume of powder to fill the capsules completely
VR_{caps·External}=remaining volume of the external capsule

Considering the combination of capsules #00 with an inner capsule #3 for the preparation of thirty capsules, the calculation of the total powder volume would be:

VT=30×0.510=15.3 mL≅15 mL

Therefore, to completely fill the remaining volume of the capsules, 15 mL of powder (IFA+Excipient) would be required.

The advantage and differential of the glass cylinder intended here is that it does not require any type of calculation. Filling the remaining volume is done quickly, easily and accurately, requiring no operator experience.

An exemplary embodiment of the present disclosure provides a glass cylinder, test-tube type, characterized by the fact that it has a special graduation suitable for estimating the remaining volume in capsule size combinations, internal and external, in which the glass cylinder is stamped with (#0 int./#000 ext.); (#4 int./#00 ext.); (#3 int./#1 ext.); (#2 int./#0 ext.); (#4 int./#1 ext.); (#1 int./#00 ext.); (#3 int./#0 ext.); (#4 int./#0 ext.); (#2 int./#00 ext.); (#3 int./#00 ext.), as well as graduations to estimate the number of capsules, stamped on the glass cylinder, and also the amount of powder to fill the remaining volume, according to each horizontal line, dispensing calculations for the preparation of combined capsules.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein the present application can be compared to a glass cylinder with special graduations and is described according to the figures:

FIG. 1 shows the front view of the glass cylinder with special graduations (used to fill the internal capsule);

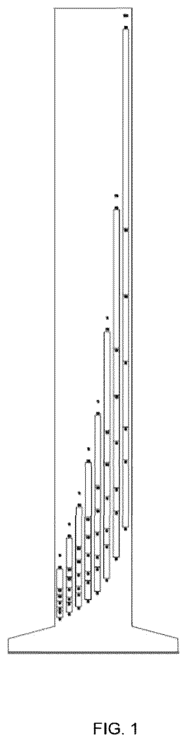

FIG. 2 shows the front view of the glass cylinder with special graduations for the remaining volume in the preparation of capsules in capsules;

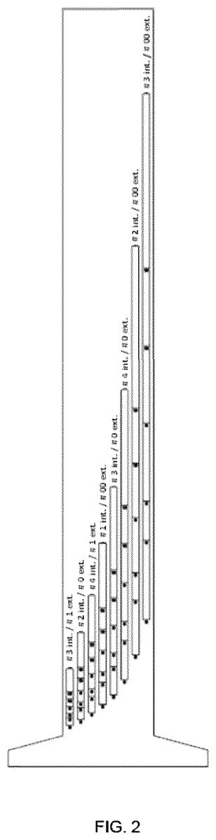

FIG. 3 illustrates a breakdown of the glass cylinder's special graduations for the remaining volume; and

FIG. 4 shows the remaining volume, space between the internal capsule and the external capsule.

### DETAILED DESCRIPTION

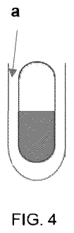

In order to overcome the deficiencies of the state of the art, the present application provides a glass cylinder (test tube type) with special and differentiated graduations for filling the remaining volume (FIG. 4) in the compounding preparation of capsules in capsules.

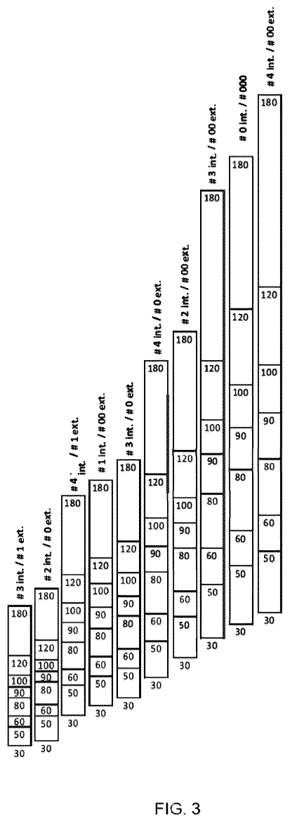

The technical solution adopted by the present application to solve these shortcomings is by means of a special graduation (FIG. 3), which allows deciding the appropriate remaining volume for each capsule size combination, internal and external, which on the glass cylinder is stamped with (#0 int./#000 ext.); (#4 int./#00 ext.); (#3 int./#1 ext.); (#2 int./#0 ext.); (#4 int./#1 ext.); (#1 int./#00 ext.); (#3 int./#0 ext.); (#4 int./#0 ext.); (#2 int./#00 ext.); (#3 int./#00 ext.), as well as the number of capsules prescribed by the prescriber (if 30, 50, 60, 80, 90, 100, 120 and 180 capsules), in the same way stamped on the glass cylinder and also the amount of powder to fill the remaining volume, according to each horizontal line, with total precision and in a practical, fast way and eliminating any type of calculation for the preparation of the combined capsules.

The capsule-in-capsule technology presents, as main advantages, the possibility of reducing the frequency of drug administration, obtaining two profiles of drug release in a single formulation (e.g. immediate release of the contents of the external capsule and slow or enteric release of content of the internal capsule), prevention of the need for nocturnal administration during the period of sleep, reduction of fluctuation/variability of the circulating level of the drug, reduction of adverse effects due to plasmatic peaks, increase of bioavailability and increase of the patient's adherence to the treatment by greater convenience and simplification of administration. It is also possible to prepare a single formulation containing ingredients with different particle sizes and physical forms, for example: powder and pellets; powder and granules; powder and mini pills.

Although exemplary embodiments of the present application have been disclosed for illustrative purposes, those skilled in the art will appreciate that various modifications, additions, and substitutions are possible, without departing from the scope of the present application. Therefore, the present application is not limited to the above-described embodiments, but is defined by the following claims, along with their full scope of equivalents.

I claim:

1. Glass cylinder, test-tube type, characterized by the fact that it has a special graduation suitable for estimating the remaining volume in capsule size combinations, internal and external, in which the glass cylinder is stamped with (#0 int./#000 ext.); (#4 int./#00 ext.); (#3 int./#1 ext.); (#2 int./#0 ext.); (#4 int./#1 ext.); (#1 int./#00 ext.); (#3 int./#0 ext.); (#4 int./#0 ext.); (#2 int./#00 ext.); (#3 int./#00 ext.), as well as graduations to estimate the number of capsules, stamped on the glass cylinder, and also the amount of powder to fill the remaining volume, according to each horizontal line, dispensing calculations for the preparation of combined capsules.
